(19) United States
(12) Patent Application Publication
(10) Pub. No.: US 2022/0097685 A1
(43) Pub. Date: Mar. 31, 2022

(54) System and Method for Automated Driving and for Automated Parking in Reverse in a Parking Space From the Automated Driving Mode

(71) Applicant: Bayerische Motoren Werke Aktiengesellschaft, Muenchen (DE)

(72) Inventors: Andreas VON EICHHORN, Muenchen (DE); Sabine VON EICHHORN, Muenchen (DE)

(21) Appl. No.: 17/425,071

(22) PCT Filed: Jan. 14, 2020
(86) PCT No.: PCT/EP2020/050748

§ 371 Date: Jul. 22, 2021

(30) Foreign Application Priority Data
Feb. 21, 2019 (DE) 10 2019 104 464.2

(51) Int. Cl. B60W 30/06; B60W 60/00

(52) U.S. Cl. CPC B60W 30/06; B60W 2554/4041; B60W 2554/80; B60W 60/00

(57) ABSTRACT

A system is configured to control an ego motor vehicle in an automated driving mode with at least automated longitudinal guidance. A parking space is detected during the automated driving mode with at least automated longitudinal guidance. It is checked whether there is a following vehicle behind the vehicle in question. If there is a following vehicle, in a first action alternative the system can bring the motor vehicle to a standstill in a stationary position in which the motor vehicle is not yet located after the parking space. After the motor vehicle reaches the stationary position, the motor vehicle is driven past the parking space in an automated fashion, and the motor vehicle is then brought to a standstill in a stationary position in which it is located after the parking space, in order then for the motor vehicle to be parked in the parking space in reverse in an automated fashion. If, on the other hand, a following vehicle is not detected at all, the system carries out a second alternative in which the motor vehicle drives past the parking space in an automated fashion, and is then brought to a standstill in a stationary position in which the motor vehicle is located after the parking space, in order then for the motor vehicle to be parked in the parking space in reverse from this position in one or more maneuvers.

### BACKGROUND AND SUMMARY OF THE INVENTION

The invention relates to a system for automated driving that is used to control a motor vehicle, in particular an automobile, in an automated driving mode with at least automated longitudinal guidance. The system is further used to park the motor vehicle in a parking space in reverse in automated fashion from the automated driving mode for the purposes of an automated parking maneuver. Further, the invention relates to a corresponding method.

The term “automated driving” is understood within the context of the document to mean driving, started for a certain period of time, with at least automated longitudinal guidance, in particular with automated longitudinal and transverse guidance, the driving being able to have an arbitrary level of automation. Illustrative levels of automation are assisted, semiautomated, highly automated or fully automated driving. These levels of automation have been defined by the German Federal Highway Research Institute (BASt) (see BASt publication “Forschung kompakt”, issue November 2012). Assisted driving involves the driver continually performing the transverse guidance, for example, while the system undertakes longitudinal guidance within certain boundaries. Examples of this are simple cruise control or adaptive cruise control (also known as ACC). Semiautomated driving (SAD) involves the system undertaking the longitudinal and transverse guidance, with the driver needing to continually monitor the system as in the case of assisted driving. An example of this is a combined system with an ACC function and a lane-keeping function. Highly automated driving (HAD) involves the system undertaking the longitudinal and transverse guidance for a certain period of time without the driver needing to continually monitor the system; however, the driver must be capable of undertaking the vehicle guidance within a certain time. In the case of fully automated driving (FAD), the system can manage the driving automatically in all situations for a specific application; this application no longer requires a driver. The aforementioned four levels of automation correspond to SAE levels 1 to 4 of the SAE (Society of Automotive Engineering) J3016 standard. By way of example, highly automated driving (HAD) corresponds to level 3 of the SAE J3016 standard. Further, there is also provision in SAE J3016 for SAE level 5 as the highest level of automation, which is not included in the definition from the BASt. SAE level 5 corresponds to driverless driving, in which the system can automatically manage all situations throughout the journey like a human driver; a driver is generally no longer required.

Parking assistance systems for automated parking are known. In parking assistance systems with automated transverse guidance, steering of the motor vehicle during the parking process is undertaken by the system. The longitudinal guidance needs to be undertaken by the driver himself by means of appropriate acceleration and braking. In parking assistance systems with automated transverse guidance and automated longitudinal guidance, some or all of the task of longitudinal guidance is also undertaken by the parking assistance system. In parking assistance systems with automated transverse guidance and automated longitudinal guidance, the steering, the brake, the vehicle drive and the direction of travel (forward or reverse travel) are generally controlled by the parking assistance system. In such parking assistance systems, the driver has for example the option of operating a control element in the vehicle cockpit, for example a key, in order to park the vehicle independently; there can be provision for the control element to need to continue to be operated during the parking maneuver.

Known parking assistance systems with at least automated transverse guidance normally comprise a parking function for automated reverse parking in a parallel parking space situated parallel to the road and optionally also in a parking space situated transversely or even obliquely with respect to the road. Before carrying out the parking maneuver, these systems use an ultrasonic sensor system to measure a parking space while driving past. If the vehicle is stopped by the driver in a valid starting position beyond the parking space in which there is a possible trajectory to a valid final parking position in the parking space, the vehicle can be parked in the parallel parking space in reverse with automated transverse guidance and possibly automated longitudinal guidance along the calculated parking trajectory from the starting position beyond the parking space. In the case of reverse parking in a perpendicular parking space or oblique parking space, a first reverse parking move is made from a starting position beyond the parking space, which involves the front of the vehicle being turned in the direction of the parking space, and then a forward move into the parking space is made subsequently.

When parking in moving traffic, it can happen that the following traffic drives up so close behind that automated parking is hampered or even impossible: if the ego vehicle is meant to be parked in a parking space and the vehicle is stopped beyond the parking space by the driver after the parking space has been measured, a following vehicle at the rear can obstruct the path to the space. If the traffic is very dense, the following vehicle at the rear is then likewise unable to move back further if further vehicles have already accumulated behind it.

The document WO 2015/150864 A1 discloses a method for parking in a parking space in which the driver manually stops the vehicle before the parking space in a position in which any other vehicle behind the ego vehicle does not hamper the ego vehicle when parking in the parking space, and then gives a command to detect a parking space ahead. On the basis of that, a trajectory is then determined and the vehicle is then parked in the parking space in automated fashion on the basis of the trajectory.

The document DE 10 2015 208 697 A1 further discloses that a vehicle traveling behind detects that a vehicle traveling ahead is in a parking situation in which the vehicle traveling ahead drives past a parking space in which the vehicle traveling ahead wishes to park in reverse. If such a parking situation is detected by the vehicle traveling behind, the vehicle traveling behind is brought to a standstill before the parking space at the level of the vehicle bounding the parking space. A similar scenario is described in the document DE 10 2015 211 732 A1.

The document DE 10 2011 003 886 A1 discloses that a vehicle traveling ahead sends information about an intended parking process to a vehicle traveling behind, as a result of which the vehicle traveling behind leaves sufficient distance to allow the vehicle traveling ahead to park.

It is an object of the invention to provide a system for automated reverse parking that prevents the parking maneuver from being hampered by a following vehicle, specifically without the need for suitable technical equipment in the following vehicle in order to leave sufficient distance for the vehicle traveling ahead.

The object is achieved by the features of the independent patent claims. Advantageous embodiments are described in the dependent claims. It is pointed out that additional features of a patent claim dependent on an independent patent claim can, without the features of the independent patent claim or just in combination with a subset of the features of the independent patent claim, form a separate invention that is independent of the combination of all of the features of the independent patent claim and that can be turned into the subject matter of an independent claim, of a divisional application or of a subsequent application. This applies in the same way to technical teachings disclosed in the description that are able to form an invention independent of the features of the independent patent claims.

A first aspect of the invention relates to a system for automated driving of a motor vehicle in an automated driving mode and for automated reverse parking in a parking space from the automated driving mode. For the automated driving mode with at least automated longitudinal guidance, the system comprises an ACC function, for example, possibly with an additional lane-keeping function. The automated driving mode can alternatively also be an automated driving mode with a higher level of automation according to SAE levels 3 to 5.

The system is set up to carry out various activities that are described below. This is typically effected by means of an electric control device that comprises one or more control units. The control device can comprise one or more processors that operate in an inventive manner under the control of one or more software programs.

As already explained above, the system is set up to control the motor vehicle in an automated driving mode with at least automated longitudinal guidance, for example for the purposes of an ACC function.

In this driving situation, the driver or another occupant can express a desire to park, for example; this is registered by the system. By way of example, there can be provision for the operation of a control element linked to a parking request, for example a parking key, to be detected. The method steps described below relating to the stopping of the vehicle take place for example on condition that the system has detected a parking request from the driver or occupant. This is not imperative, however: in an automated driving mode according to SAE level 4 or 5, it would also be conceivable for the vehicle to independently detect the need to park on reaching a driving destination and to trigger parking of the vehicle without a person in the vehicle communicating a parking request to the system.

During the automated driving mode with at least automated longitudinal guidance, a parking space, preferably ahead, is detected by the system. The parking space is for example a parallel parking space. Optionally, the system is set up to detect a perpendicular parking space or even a diagonal parking space. To detect a parking space ahead, a sufficiently predictive surroundings sensor system is preferably used, for example a laser-based lidar (light detection and ranging), a camera and/or a radar. Alternatively or additionally, a vacant parking space ahead can also be detected by using information about the position of the parking space that is received from other road users or from an infrastructure by means of C2X, and comparing said information with the vehicle position. It would also be conceivable, however, to use an ordinary ultrasonic sensor system directed to the side, which detects the parking space only when the motor vehicle is approximately at the level of the parking space; in this case, the vehicle can bring the vehicle to a standstill only later (for example only at the level of the parking space and not before the parking space already) in comparison with a predictive surroundings sensor system, however.

Further, the system checks whether a following vehicle is present behind the vehicle. This is preferably accomplished by using a rearward-looking surroundings sensor system, for example a radar sensor system, a camera or a rear-located ultrasonic sensor system for a parking assistance system. It is advantageous if the surroundings sensor system has a longer range (for example a range of 20 m) than an ordinary rear ultrasonic sensor system of a parking system (for example with a range of 5 m or less) so that vehicles traveling further behind the vehicle can also be detected.

If it is established that a following vehicle is present, the system is able, in a first action alternative, to bring the motor vehicle to a standstill with a kind of standstill position in which the motor vehicle is not yet beyond the parking space, for example to a standstill position just before the parking space or at the level of the parking space. The vehicle thus slows to a standstill before it has passed the parking space. It is pointed out that the first action alternative is not necessarily already carried out when the following vehicle is present, but rather can be dependent on one or more further conditions. By way of example, while approaching the parking space, the physical or temporal distance between the ego vehicle and the following vehicle is determined, and a check is performed to determine whether a specific distance criterion is satisfied. Only if the distance criterion is satisfied is the first action alternative carried out and the motor vehicle brought to a standstill with the kind of standstill position in which the motor vehicle is not yet beyond the parking space. By way of example, the distance criterion checked is whether the temporal or physical distance from the following vehicle is less than or less than or equal to a specific upper threshold value (e.g. a temporal threshold value in the range from 1 to 2 s). Further, it would be conceivable for the temporal or physical distance from the following vehicle to additionally also need to be greater than, or greater than or equal to, a specific lower threshold value in order for the vehicle to actually be slowed to a standstill.

As a result of the vehicle being brought to a standstill position in which the motor vehicle is not yet beyond the parking space, the following vehicle is generally brought to a halt before the parking space, which means that it subsequently cannot obstruct the path to the parking space for parking.

For the purposes of the first action alternative, after reaching the standstill position in which the motor vehicle is not yet beyond the parking space, the motor vehicle is driven past the parking space in automated fashion and then the motor vehicle is brought to a standstill with a standstill position in which the motor vehicle is beyond the parking space, so as then to park the motor vehicle in a parking space in reverse in automated fashion.

If, on the other hand, no following vehicle at all is detected or if the distance from a following vehicle is possibly too great, the system carries out a second action alternative, in which the motor vehicle drives past the parking space in automated fashion without stopping beforehand, is then brought to a standstill with a standstill position in which the motor vehicle is beyond the parking space, so as then to park the motor vehicle in the parking space in reverse from this position in one or more moves in automated fashion.

By already stopping the motor vehicle early before the parking space or at the level of the parking space, depending on the situation, when there is a following vehicle, it is possible to prevent the parking path from being obstructed by the following vehicle, since said vehicle stops before the parking space and does not then obstruct the path to the parking space. This allows automated parking even in dense following traffic.

It is advantageous if, for the purposes of the first action alternative with a following vehicle present, a check is performed, before moving off again, to determine whether the following vehicle has come to a standstill. In reaction to the discovery that the vehicle has come to a standstill, the ego motor vehicle is then moved off again and taken past the parking space, so as then to come to a standstill beyond the parking space. To check that the following vehicle is at a standstill, it is possible to measure the distance from the following vehicle at various times after the ego vehicle is at a standstill, for example, and to establish that said distance remains constant.

In one illustrative embodiment of the invention, if the driver traveling with the ACC function activated expresses the desire to park, a parking space in front of the vehicle has been detected and a following vehicle is present, then the ego motor vehicle is slowed to a standstill before it has passed the parking space. At the same time or even at an earlier time, the turn indicator is turned on. After slowing, in particular after reaching a standstill, a check is performed to determine whether the following vehicle is also already stationary. As soon as the following vehicle has also reached a standstill, the ego vehicle is moved off again and then passes the parking space. The following vehicle will then usually not move off, which means that the path to the parking space is not obstructed and the ego vehicle can park.

A second aspect of the invention relates to a method for automated driving of a motor vehicle in an automated driving mode and for automated reverse parking in a parking space from the automated driving mode. The method has the following steps:
controlling the motor vehicle in an automated driving mode with at least automated longitudinal guidance;
during the automated driving mode,
   detecting a parking space, and
   checking whether a following vehicle is present behind the motor vehicle,
if a following vehicle is present,
   bringing the motor vehicle to a standstill with a kind of standstill position in which the motor vehicle is not yet beyond the parking space,
   subsequently driving the motor vehicle past the parking space in automated fashion, bringing the motor vehicle to a standstill with a standstill position in which the motor vehicle is beyond the parking space, and then parking the motor vehicle in the parking space in reverse in automated fashion;
if a following vehicle is not present, driving the motor vehicle past the parking space in automated fashion, bringing the motor vehicle to a standstill with a standstill position in which the motor vehicle is beyond the parking space, and then parking the motor vehicle in the parking space in reverse in automated fashion.

The above explanations relating to the system according to the invention based on the first aspect of the invention also apply in corresponding fashion to the method according to the invention based on the second aspect of the invention. Advantageous embodiments of the method according to the invention that are not described explicitly at this juncture and in the patent claims correspond to the advantageous exemplary embodiments of the system according to the invention that have been described above or in the patent claims.

The invention is described below on the basis of an exemplary embodiment with the aid of the appended drawings.

### BRIEF DESCRIPTION OF THE DRAWINGS

FIG. 1 shows an exemplary embodiment of a flowchart for a system according to an embodiment of the invention; and

FIG. 2a, 2b shows illustrative parking in a plan view.

### DETAILED DESCRIPTION OF THE DRAWINGS

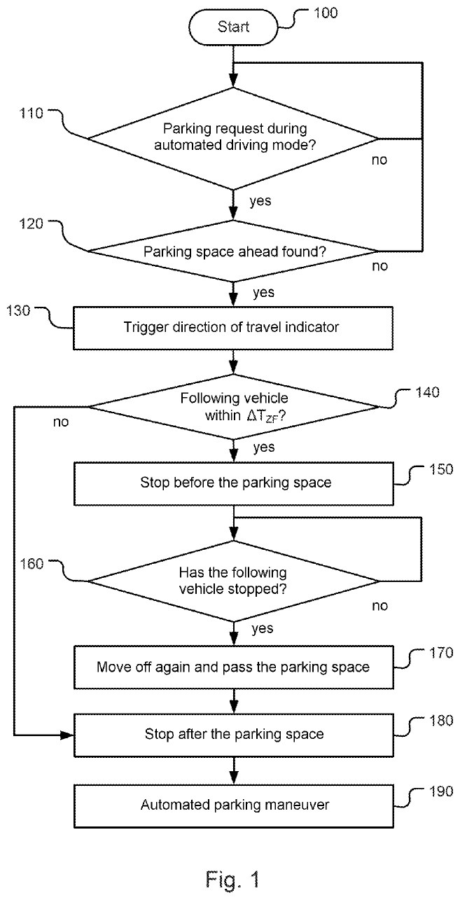

FIG. 1 depicts an exemplary embodiment of a flowchart for a system. The flowchart assumes that the ego motor vehicle 1 is in an automated driving mode with at least automated longitudinal guidance. By way of example, the vehicle is in a driving mode with the ACC function activated, wherein the speed of travel in no traffic without a vehicle traveling ahead is regulated to a predefined speed value and, when the vehicle is behind traffic, the distance from a vehicle traveling ahead is regulated. By way of example, the vehicle is traveling with at least automated longitudinal guidance along an urban road with, in the case of traffic driving on the right, vehicles parked on the right-hand side of the road.

The test 110 checks whether there is a parking request from the driver during the automated driving mode. A parking request from the driver is inferred for example if a parking key integrated in the vehicle cockpit was operated by the driver beforehand or a parking menu on the screen of the infotainment system was activated.

If, when a parking request is active, a parking space 2 ahead is found by way of a surroundings sensor system (e.g. a camera or a lidar or a combination of multiple different sensor types) with a certain level of prediction (see test 120), a direction of travel indicator (also referred to as turn indicator) of the ego vehicle 1 is triggered in step 130 according to the side of the road on which the parking space 2 is found.

The test 140 checks whether a following vehicle 3 is behind the ego vehicle 1 in a predefined time window ΔT_{ZF}. The predefined time interval ΔT_{ZF} is for example in the range from 1 to 2 s, for example ΔT_{ZF}=1.5 s.

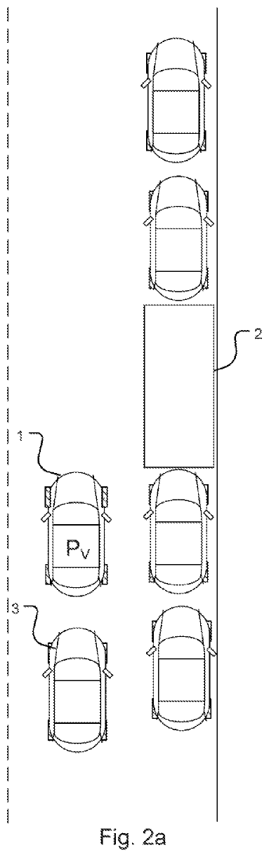

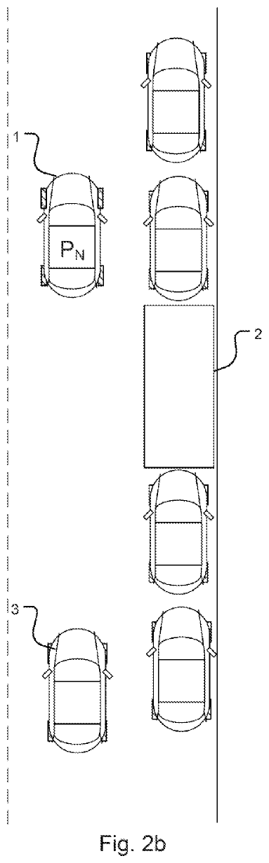

If a following vehicle 3 is present behind the ego vehicle 1 in the time window ΔT_{ZF}, the ego vehicle 1 is brought to a standstill before the parking space 2 with a standstill position Pv in automated fashion by way of the system (see step 150). The situation with the stationary vehicle 1 before the parking space 2 is depicted in FIG. 2a, the ego vehicle having stopped approximately at the level of the motor vehicle bounding the parking space. If the ego vehicle 1 stops, the following vehicle 3 is also stopped.

If the test 160 has established that the following vehicle has stopped, the ego vehicle moves off again, passes the parking space in automated fashion (see step 170) and is then brought to a standstill in a standstill position PN beyond the parking space (see step 180). This situation is depicted in FIG. 2b. The following vehicle 3 will then usually not move off immediately, which means that the path to the parking space 2 is not obstructed and the ego vehicle 1 can park in the parking space 2 in reverse in automated fashion (see step 190).

If the test 140 has established that there is no following vehicle behind the ego vehicle 1 within the time window ΔT_{ZF}, the motor vehicle 1 passes the parking space without stopping beforehand and then stops beyond the parking space 2 in automated fashion. Subsequently, the reverse automated parking maneuver in the parking space 2 is then effected.

The example above has not allowed for the possibility that the following vehicle 3 overtakes the ego vehicle 1 after the ego vehicle 1 has stopped. This could be allowed for by virtue of the test 160 checking, as an alternative, whether the following vehicle 3 has overtaken the ego vehicle 1.

1. to 7. (canceled)

8. A system for automated driving of a motor vehicle in an automated driving mode and for automated reverse parking in a parking space from the automated driving mode, the system comprising:
one or more control units configured to:
control the motor vehicle in an automated driving mode with at least automated longitudinal guidance,
during the automated driving mode,
detect a parking space, and
check whether a following vehicle is present behind the motor vehicle, and
(i) when a following vehicle is present,
bring the motor vehicle to a standstill at a standstill position in which the motor vehicle is not yet beyond the parking space,
subsequently drive the motor vehicle past the parking space in automated fashion, to bring the motor vehicle to a standstill with a standstill position in which the motor vehicle is beyond the parking space, and to then park the motor vehicle in the parking space in reverse in automated fashion,
(ii) when a following vehicle is not present,
drive the motor vehicle past the parking space in automated fashion, to bring the motor vehicle to a standstill at a standstill position in which the motor vehicle is beyond the parking space, and to then park the motor vehicle in the parking space in reverse in automated fashion.

9. The system according to claim 8, wherein
the one or more control units are configured so as, when a following vehicle is present, to bring the motor vehicle to a standstill with a standstill position before the parking space.

10. The system according to claim 8, wherein
the one or more control units are configured so as, when a following vehicle is present, to bring the motor vehicle to a standstill with a standstill position at the level of a motor vehicle bounding the parking space.

11. The system according to claim 8, wherein the one or more control units are configured so as, when a following vehicle is present,
to check, prior to driving past the parking space, whether the following vehicle has come to a standstill, and
to react to the discovery that the following vehicle has come to a standstill by moving of the motor vehicle and driving the motor vehicle past the parking space.

12. The system according to claim 8, wherein the one or more control units are configured so as,
while approaching the parking space, to determine a physical or temporal distance between the ego vehicle and the following vehicle,
to check whether the distance satisfies a specific distance criterion, and
to react thereto by bringing the motor vehicle to a standstill at a standstill position in which the motor vehicle is not yet beyond the parking space.

13. The system according to claim 8, wherein
the one or more control units are configured to automatically trigger a direction of travel indicator following detection of the parking space.

14. A method for automated driving of a motor vehicle in an automated driving mode and for automated reverse parking in a parking space from the automated driving mode, the method comprising the steps of:
controlling the motor vehicle in an automated driving mode with at least automated longitudinal guidance;
during the automated driving mode,
detecting a parking space, and
checking whether a following vehicle is present behind the motor vehicle, and
(i) when a following vehicle is present,
bringing the motor vehicle to a standstill at a standstill position in which the motor vehicle is not yet beyond the parking space,
subsequently driving the motor vehicle past the parking space in automated fashion, bringing the motor vehicle to a standstill with a standstill position in which the motor vehicle is beyond the parking space, and then parking the motor vehicle in the parking space in reverse in automated fashion;
(ii) when a following vehicle is not present, driving the motor vehicle past the parking space in automated fashion, bringing the motor vehicle to a standstill at a standstill position in which the motor vehicle is beyond the parking space, and then parking the motor vehicle in the parking space in reverse in automated fashion.

15. A computer product comprising a non-transitory computer-readable medium having stored thereon program code which, when executed via one or more control units, executes the acts of:
controlling the motor vehicle in an automated driving mode with at least automated longitudinal guidance;
during the automated driving mode,
detecting a parking space, and
checking whether a following vehicle is present behind the motor vehicle, and
(i) when a following vehicle is present,
bringing the motor vehicle to a standstill at a standstill position in which the motor vehicle is not yet beyond the parking space,
subsequently driving the motor vehicle past the parking space in automated fashion, bringing the motor vehicle to a standstill with a standstill position in which the motor vehicle is beyond the parking space, and then parking the motor vehicle in the parking space in reverse in automated fashion;
(ii) when a following vehicle is not present, driving the motor vehicle past the parking space in automated fashion, bringing the motor vehicle to a standstill at a standstill position in which the motor vehicle is beyond the parking space, and then parking the motor vehicle in the parking space in reverse in automated fashion
